(19) United States
(12) Patent Application Publication
(10) Pub. No.: US 2022/0383345 A1
(43) Pub. Date: Dec. 1, 2022

(54) RELATIVE POSITION QUANTIFICATION SYSTEMS AND METHODS

(71) Applicant: William Zeidler, Lisle, IL (US)

(72) Inventor: William Zeidler, Lisle, IL (US)

(21) Appl. No.: 17/303,531

(22) Filed: Jun. 1, 2021

(51) Int. Cl. G06Q 30/02; G06F 16/332; G06N 5/04

(52) U.S. Cl. CPC G06Q 30/0203; G06F 16/3329; G06N 5/04

(57) ABSTRACT

Methods, systems, and apparatuses, including computer programs encoded on computer-readable media for receiving a first answer to an open-ended question from a first user, generating a first user opinion value comprising a first sum comprising all interaction values associated with the first user rating respective answers to the open-ended question, receiving a rating of the first answer from a second user, generating a second user opinion value comprising a second sum comprising all interaction values associated with the second user rating respective answers to the open-ended question including the first answer from the second user, generating a new interaction value based on the first sum of all interaction values, the second sum of all interaction values, and the rating of the first answer from the second user, and adjusting a position of the first user and a position of the second user in the ordinal data based on the new interaction value. The interaction values may be based on evaluations of ratings based on a scale measuring agreement or disagreement and the first user opinion value and the second user opinion value numerically represents the respective user's opinion.

### BACKGROUND

Opinion systems may be conducted over the internet and accessed by users in which the user is able to express their opinion and/or answer to a question. Billions of dollars are spent annually on opinion research by just the federal government. Opinion polls are usually designed to represent opinions of a population by conducting a series of questions and extrapolating generalities. Many surveys are based on closed-ended questions that are comprised of multiple-choice, ordinal, interval, or ratio questions. Closed-ended questions are easy for survey participants to answer but obtain a limited set of data. Existing methodologies involving the use of computers to collect and analyze results are most effective when the data is categorical and the number of options for the respondent to choose from is limited. This simplifies survey administration but does not allow for any new insight to be gained from an analyzing user ratings of the answers.

### SUMMARY

As an example, it would be desirable to have systems, methods, and apparatuses that allow for relative positioning of opinions on a spectrum of opinions by analyzing ratings of those opinions by other users. In general, an aspect of the subject matter described in this specification may be implemented as an ordinal data quantifying system. The ordinal data quantifying system may comprise a poll interface, a poll engine, and a database. In some implementations, the poll engine may be configured to receive an open-ended question from a first user using the poll interface, receive a first answer to the open-ended question from the first user using the poll interface, generate, using the database, a first user opinion value comprising a first sum comprising all interaction values associated with the first user rating respective answers to the open-ended question not including the first answer, receive a rating of the first answer from a second user using the poll interface, generate, using the database, a second user opinion value comprising a second sum comprising all interaction values associated with the second user rating respective answers to the open-ended question including the first answer from the second user, and generate a new interaction value based on the first sum comprising all interaction values, the second sum comprising all interaction values, and the rating of the first answer from the second user. The poll engine may further be configured to adjust a position of the first user and a position of the second user in the ordinal data based on the new interaction value. The interaction values may be based on evaluations of ratings based on a scale measuring agreement or disagreement. The first user opinion value and the second user opinion value may numerically represent the respective user's opinion.

In some implementations, the poll system may be further configured to randomly, pseudo-randomly, or systematically select the first answer from a plurality of answers to the open-ended question and send the first answer to the second user using the poll interface. The poll system may be further configured to compare the position of the first user and the position of the second user, determine the first user and the second user are closer in the ordinal data than a predetermined threshold amount, and predict an answer to a second open-ended question by the second user based on an answer to the second open-ended question by the first user. The scale measuring agreement or disagreement may be a Likert scale. The second open-ended question may be related to the open-ended question. The poll system may be further configured to present the predicted answer to the second open-ended question to the second user as a possible answer using the poll interface.

In some implementations, the poll system is further configured to compare the position of the first user and the position of the second user, generate a compromise answer in between an answer associated with the first user and an answer associated with the second user based on the comparison, and present the compromise answer to at least one of the first user or the second user using the poll interface. Generating the compromise answer may comprise determining an answer associated with a user with a position between the position of the first user and the position of the second user in the ordinal data.

In some implementations, the poll system is further configured to generate a graphic of all ordinal data including the position of the first user and the position of the second user, wherein the positions are expressed and presented in order from negative to positive. In some implementations, a user viewing the graphic can interact with a graphic representing each respective user to view an answer associated with the respective user using the poll interface.

In some implementations, the poll system is further configured to generate a graphic of all answers placed in positions associated respective users using the ordinal data including the position of the first user and the position of the second user. In some implementations, a user viewing the graphic can interact with a graphic representing each respective answer to view information about a user associated with the respective answer using the poll interface.

In some implementations, systems, methods, and apparatuses are described that solve a techno-centric problem comprising a need to create an agreed upon numerical method of categorizing opinions. Rather than having one metric (or scale) in which answers to all questions would be measured against, the metric's meaning may be unique to each question. Presuming the opinions/answers are arranged in their true (or close to the correct) order, the quantified values can serve as reference points that allow for a shared frame of reference in which the results to the whole question can be viewed. If the answers are not yet in the correct order, the results are likely still viable as data is often expected to include some noise and irregularities. Requiring a higher minimum number of interactions may help to reduce the noise.

In some implementations, systems, methods, and apparatuses are described that solve a techno-centric problem of determining a relationship along a spectrum of answers to open-ended questions. The systems, methods, and apparatuses may solve the technocentric problem by using ratings of the answers by users to allow the relative positions of the answers along the spectrum to generate as an emergent phenomenon. The resultant spectrum of answers may then be used to solve other techno-centric problems. For example, the spectrum of answers may be used to order written and expressed answers between two opposing viewpoints such as positive and negative, political position one and political position two, and the like. In another example, the spectrum of answers may be used to guess the position of an unrated answer or opinion based on a similarity to other rated answers or opinions. In another example, the spectrum of answers may be used to generate a predicted answer or opinion for a user based on the position of the user obtained by the user rating the answers of other users. In another example, the spectrum of answers may be used to determine answers or opinions that are similar due to proximity or clustering on the spectrum. Open-ended questions do not limit the number of possible responses or restrict how an answer may be conveyed and may often require a person to categorize the results according to their own ability to understand what the respondent expressed. Using a human to interpret the results introduces the possibility of intentional or unintentional bias into the analysis process. Sentiment analysis can be used to allow computers to categorize statements by assigning them numerical ratings. The ratings may be specific to the statements being analyzed and serve to classify written content into positive, neutral and negative categories. The algorithms used to conduct sentiment analysis may be trained to score sentences from the words and the sentence structure used based upon a database of previously scored data. They do not compare the meaning of statements against each other. While sentiment analysis could optionally be used to provide further analysis of individual user's answers, it differs greatly from the systems and methods claimed.

In some implementations, systems, methods, and apparatuses are described that solve a techno-centric problem of graphically displaying ordinal data of users and/or the associated answers written by the users showing the relative relationship between the users for an open-ended question. For example, the relative relationship between user answers may be displayed on a 1-dimensional line showing related answers clustered together. In another example, the relative relationship between user answers to two related open-ended questions may be displayed on a 2-dimensional graph. These graphical relationships can be further extrapolated to any number of dimensions for any number of related open-ended questions.

In some implementations, systems, methods, and apparatuses are described that solve a techno-centric problem of allowing a computing system to determine a usually subjective determination on whether a question has been well written and/or designed. The systems, methods, and apparatuses may solve the technocentric problem by determining that a question has been well written and/or designed by analyzing the ordinal spread of the users and/or the associated answers written by the users. For example, if a very strong correlation is expected between two questions by a user but no correlation is found, reviewing how the questions were written should be the user's first step in the process of determining a reason for the discrepancy. Statistical methods, like multiple correlation, that would allow for multiple questions to be compared at the same time may also be used to determine if the results from one or more questions differs from expectations.

In some implementations, established statistical methods may be used to analyze the data, make predictions, and determine the quality of or confidence in the predicted values. In some implementations, Spearman's rank correlation coefficient (Spearman's rho) may be used to determine the correlation between the two questions. In order to allow for statistical methods like monotonic regression and linear regression to be used to generate predicted values, it may be necessary for the ordinal data to be temporarily viewed as interval or ratio data if required. However, the results will still be ordinal. In some implementations, methods like the pool-adjacent-violators algorithm (PAVA) may be utilized to ensure monotonicity by correcting for some of the variability in the data. In some implementations, a subset of the available data may be used to compare the two questions as not all users that have a value for the first question will have a value for the second question and not all users that have a value for the second question will have a value for the first question. If the subset of users who have answered both questions is not sufficiently large, it may not be possible to compare the two questions. In some instances, statistical methods of evaluating the results, such as determining the coefficient of determination for a regression line, may be used to assess the likelihood that the predicted results are valid. In some implementations, the predicted values generated by multiple methods may produce different values which may be displayed to the user as separate predictions or used to create or select a single predicted value to display. In some implementations, a user's predicted value for a question could be used as the starting value for their opinion for that question.

In some implementations, systems, methods, and apparatuses are described that solve a techno-centric problem of facilitating the creation of a shared set of parameters in which to view complex concepts by using multiple individuals' interpretations to define the parameters. The individuals responding to the poll may agree on a nominal definition of a term yet differ in their perception of its meaning. For example, the color cyan can be defined as being halfway between green and blue on the color wheel and is comprised of the maximum amount of green, the maximum amount of blue, and the absence of red. Because that definition is dependent upon the hue of green and the hue of blue each individual perceives as “green” and “blue” respectively, cyan can correctly be perceived as being both a greenish-blue and a bluish-green color. Furthermore, the color aqua has the same definition, however, some individuals may perceive it to be distinct from cyan. Several common methods, such as the RGB and CMYK color models, have been established to define colors in a quantifiable manner which can be easily understood. Cyan and aqua coincidentally share the same color codes RGB(0,255,255) and CMYK(100,0,0,0) and are merely different names for the same color. In some implementations, the methods and systems claimed similarly uses numerical values to define and categorize opinions.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The accompanying drawings, which are incorporated herein and constitute part of this specification, illustrate examples described in the disclosure, and together with the general description given above and the detailed description given below, serve to explain the features of the various implementations. However, the drawings are provided for purposes of illustration only and merely depict example implementations of the invention to facilitate the reader's understanding of the invention. Therefore, the drawings should not be considered limiting of the breadth, scope, or applicability of the invention. It should be noted that for clarity and ease of illustration, these drawings are not necessarily drawn to scale although some of the drawings show measurements as an exemplary implementation.

FIG. 1 is a block diagram of a relative quantification system in accordance with an illustrative implementation.

FIG. 2 is a block diagram of user interactions added to a database according to an example implementation.

FIG. 3 is a block diagram of an algorithm to adjust relative interaction scores according to an example implementation.

FIG. 4 is a block diagram of an algorithm to create results data sets according to an example implementation.

FIG. 5 is a block diagram of a detailed algorithm to adjust relative interaction scores according to an example implementation.

FIGS. 6a-6c are an illustration of a detailed algorithm to adjust relative interaction scores according to an example implementation.

FIG. 7 is a block diagram of a computer system in accordance with an illustrative implementation.

Like reference numbers and designations in the various drawings indicate like elements.

### DETAILED DESCRIPTION

Before turning to the figures, which illustrate certain exemplary implementations in detail, it should be understood that the present disclosure is not limited to the details or methodology set forth in the description or illustrated in the figures. It should also be understood that the terminology used herein is for the purpose of description only and should not be regarded as limiting. Additionally, the specific order or hierarchy of steps in any methods disclosed herein are merely example approaches. Based upon design preferences, the specific order or hierarchy of steps of any disclosed methods or processes can be re-arranged while remaining within the scope of the invention. Thus, those of ordinary skill in the art will understand that the methods and techniques disclosed herein present various steps or acts in a sample order, and the invention is not limited to the specific order or hierarchy presented unless expressly stated otherwise.

The systems and methods may be designed to order written and/or expressed answers to open-ended opinion-based questions. The systems and computer implemented methods may be intended to be used with multiple individuals, the final number of which does not need to be known. The goal of the invented method may be to determine a quantified value for each individual's opinion. In same implementations, all quantified values produced by this method may be ordinal and can be graphed or used with one or more analytical methods.

In some implementations, some assumptions regarding opinions may be made. Opinions may be assumed to have a relative position in relation to other opinions, be fluid and capable of being influenced, and be defined by both things that the individual agrees with and disagrees with. One example of this may be the political spectrum where certain ideologies are colloquially described as being “on the left” or “on the right”. These views may change at an individual or societal level over time and that change is often due to the influence of one or more factors.

In some implementations, to reasonably facilitate the method as described in the following paragraphs, a website or other interface using the invented method may have a way to identify each individual user (e.g., via a log-in system) and keep a record of their actions in a database.

In some implementations, the selection of an appropriate question may be of importance. Questions about broad subjects that can be answered with at least two clearly distinct points of view that cannot be answered with a “yes” or “no” may function best. The method may not provide meaningful results when used with questions that allow for categorical/nominal answers. For example, asking “What do you think about ______?” may allow for participants to provide valid answers.

In some implementations, the individual that creates a question may be either a participant or non-participant. Then if a non-participant authors and submits a question, the first participant to respond (User A) must provide a written answer (Answer A) to the question. If the question is created by User A, they may also be required to provide an answer (Answer A) to their own question. The Question and Answer A may be submitted to the website's database. User A may not take any additional actions until another answer has been submitted. Each participant is only allowed to submit one written answer.

In some implementations, a second user (User B) may discover the question asked by User A via a link or from the results of a search function. User B may either provide an answer (Answer B) or a rating of an existing answer. Rating an existing answer may be preferable as to potentially eliminate the possibility of having some quantified values that do not have a relationship with the rest of the data. For this reason, all participants (with the exception of User A) may be directed to rate at least one existing answer prior to providing a written answer.

In some implementations, for User B to rate Answer A, Answer A must be displayed to User B along with a method for User B to indicate their level of agreement or disagreement to Answer A. This information may be captured by using a Likert scale and is designated as an interaction for both users. Note that if User B provides a written answer to the question and User A rates Answer B, there may be a difference between the two interactions.

The first interaction, Interaction BA (User B rating Answer A), may be evaluated by an algorithm which uses User B's rating of Answer A, User A's current quantified value and User B's current quantified value. In situations where there have been no prior interactions involving User A, Answer A, or User B, both quantified values are assigned the starting value (e.g., ‘0’). Similarly, in situations where one of User A or User B has had no prior interactions, there respective quantified value is the starting value (e.g., ‘0’) while the other user (who has prior interactions) has a quantified value equal to the sum of the interactions in they were involved in. Finally, in situations where both User A and User B has had prior interactions, each respective user has a respective quantified value equal to the sum of the interactions each respective user was involved in. As a clarification it is noted that Interaction BA is differs from a possible Interaction AB. If both users provide an answer, it is possible for both interactions to occur.

In some implementations, the algorithm uses the quantified value for each user involved in the interaction and the rating as inputs and outputs a single value which may be added to User A's quantified value. The additive inverse of the output value may be added to User B's quantified values. In some implementations, the algorithm may use the distance between the two quantified values as a means of estimating the expected level of agreement: the greater the difference between the quantified values, the more dissimilar the opinions are expected to be. The output value can be thought of as being weighted proportionally to the complement of the expectation of agreement. In some implementations, the rating functions as an additional variable used to weight the value of the output and determines the sign of the output value. If agreement was expressed, both quantified values may move towards (or in this particular instance past) each other by the value produced by the algorithm. If User B expressed disagreement, the result of Interaction BA may have both quantified values moving away from each other by the value produced by the algorithm. Should Interaction BA result in “neither agree nor disagree” being selected, the resulting value from the algorithm will be 0. If a third user, User C, were to then rate Answer A, Interaction CA may cause the algorithm to compare User C's quantified value (0) with User A's current quantified value which may or may not be 0 due to Interaction BA.

There are a few potential solutions to technical problems that may occur from this method. First, it may be possible to measure the opinions of individuals who did not provide a written answer to the question. As some individuals may hold opinions that are hard to express, or do not wish to express due to the subject matter of the question, this method allows for their opinions to be represented.

Second, as the number of participants and interactions increases, the range of the data may slowly increase as the quantified values slowly spread out. Over time, it is expected that the opinions may eventually move towards their true position if all participants rate answers in a manner that is rational and in line with their own views. In some implementations, quantified values that are close to each other may be assumed to be similar opinions. In some implementations, graphing the data or using cluster analysis may show the popularity of opinions and if there is potential for a “middle ground” opinion to be a valid answer to the question or not.

Third, in some implementations, assuming no data is removed, the mean of all the quantified values will equal 0 (or the starting value if a non-zero value is used instead). If any data is removed, the mean may shift and it can be used as a measure of central tendency. Because users with fewer interactions are more likely to have values closer to the starting value, their data may have a bias towards the center. In some implementations, this may be partially corrected for by requiring a minimum number of interactions and only selecting the quantified values from the database that meet or exceed that value.

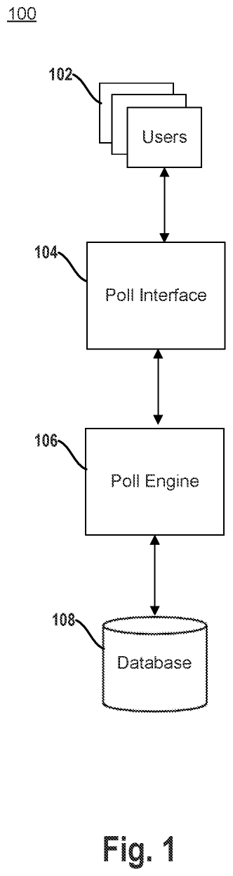

FIG. 1 is a block diagram of a relative quantification system 100 in accordance with an illustrative implementation. The system includes one or more users 102 that can interact with a poll interface 104 of relative quantification system 100. Actions by the users 102, e.g., entering questions, entering answers, and evaluating the answers of others can be stored in a database 108. For example, a database, a file system, a data store, etc., can be used to store these user actions. The database 108 can be one or more separate data stores or they can be a single data store.

As the actions of users 102 are stored in the database 108, a poll engine 106 is used to execute the rules and generate related values, graphs, and documents. The poll engine 106 can include various algorithms, some of which access data in the database 108. As the poll engine 106 is interpreting the system rules, data from the database 108 can be accessed as needed. Data can be sent in the system 100, e.g., from/to the users 102, the poll interface 104 documents interface 104, etc., through known networks, e.g., WANs, LANs, WiFi, internet, etc.

In some implementations, the poll interface 104 may be configured to allow an ability to access, register, and/or sign-in to a website. The poll interface 104 may allow registration to allow users 102 to create new questions to create a poll. In some implementations, registration may be required to answer a question or to rate the answers of others to a question. Questions may be created by non-participant question authors that create a question for others to answer but do not answer the question or rate the level of agreement/disagreement with the answers of others to the question. For example, a user 102 may create a question for others to answer using poll interface 104. The user 102 may further provide an answer for their own question using the poll interface 104 if they are not a non-participant question author. The user 102 may further provide an answer for their own question using the poll interface 104. The user 102 may further provide an answer for a question asked by another user 102. In some implementations, the poll interface 104 may be configured to prompt a user 102 to provide a question on a topic and/or provide an answer. A question should be written about broad subjects that can be answered with at least two clearly distinct points of view. The question should not be answerable with a “yes” or “no” or other non-substantive answer. In other words, the question should be open-ended and should allow for a spectrum of views between at least two distinct points of view.

In some implementations, the poll interface 104 may be configured to present two or more questions (e.g., a plurality of questions) for selection by a user 102. The poll interface 104 may be configured to accept a selection of one of the plurality of questions and present a previously written answer to the selected question. The presented previously written answer may be a randomly, pseudo-randomly, or systematically selected answer from a plurality of answers. The poll interface 104 may be configured to accept input that rates answers being presented. The input may be a selection of a level of agreement or disagreement. For example, the input may be a selection from a Likert scale of agreement/disagreement.

In some implementations, the poll engine 106 may be configured to select a question for presentation to a user 102. Two or more questions (e.g., a plurality of questions) may be selected for presentation to a user 102. The poll engine 106 may be configured to select an answer to the question for presentation to a user 102 from two or more possible answers (e.g., from a plurality of available answers). The poll engine 106 may be configured to randomly, pseudo-randomly, or systematically select an answer to the question for display to a user 102. The answer may not have been provided by the user 102 or rated by the user 102. The poll engine 105 may be configured to randomly, pseudo-randomly, or systematically select the answer from two or more possible answers (e.g., a plurality of available answers). In other words, the selection of answers to present to the user can be done in a random, pseudo-random, or systematic manner. In some implementations, an implemented method may be categorized as pseudo-random as it assigns a fixed percentage chance to select a category. The answer to be displayed to the user may be selected randomly from the selected category. This may allow all answers to still have a chance to be displayed while decreasing the chance that a less desirable or less relevant answer will be displayed. For example, if three categories are created and each category has a one-third chance of being selected and the number of answers in each category is the same, the odds of the selected answer being from the first, second and third categories are 61.11%, 27.78%, and 11.11% respectively. The categories may be arranged in a hierarchical order so that if a category is selected which contains no answers, an answer may be selected from the subsequent category. The set of answers for each category may include the set of answers from the prior category and all previous categories. A category or set of categories may be determined by one or more criteria. The criteria used to categorize answers may be based upon any metric related to the answer (e.g., how recently the answer was submitted, the number of times the answer has been reported by other users, the frequency of “neither agree nor disagree” ratings received, etc.). Other criteria, such as a user's demographic information (e.g., location, nationality, etc.), a user's profile information, a user's relationship or connection with the author of the answer, and the like, can also be selected for in the same manner in order to prioritize interactions between those users if so desired.

In some implementations, the poll engine 106 may be configured to determine a difference between a sum of all interaction scores involving the author of the selected answer and a sum of all interaction scores to the question for user 102. The poll engine 106 may be configured to generate a value that is dependent upon the level of agreement or disagreement. In some implementations, the value is further based or dependent upon a sum of all interaction scores for the question for the author of the question. In some implementations, the value is further based or dependent upon a sum of all interaction scores for the question and the user 102. In some implementations, the value is further based on the difference between those two sums. In some implementations, a calculation of a small difference between two values associated with respective users 102 may indicate that agreement or substantial agreement is expected. In some implementations, a calculation of a large difference between two values associated with respective users 102 may indicate that disagreement or substantial disagreement is expected. In some implementations, if a Likert scale rating is in line with an expectation that there will be agreement or disagreement, the generated value may be expected to be small. In other words, there will not be much change in the relation of interaction scores associated with respective users 102. If the Likert scale rating is not in line with an expectation that there will be agreement or disagreement, the generated value may be larger. In other words, there may be greater change in the relation of interaction scores associated with the respective users 102.

In some implementations, the poll engine 106 may be configured to adjust values of a user 102 and an author of an answer to the question (another user 102 who may or may not be the author of the question) away from each other if there is disagreement between the two. The values associated may move away from each other by the same amount. In other words, a sum of all interaction scores involving the author of the selected answer to Question A and a sum of all interaction scores to the question from user 102 move away from each other by the same amount. The values associated may move toward each other by the same amount. In other words, a sum of all interaction scores involving the author of the selected answer to the question and a sum of all interaction scores to the question from user 102 move toward each other by the same amount.

In some implementations, the poll engine 106 may be configured include a user's 102 result in a results data set only if a required number of interactions per participating user 102 is achieved. The results data set may be specific to a particular question. For example, the poll engine 106 may receive ratings for three different answers for a given question from a user 102 (e.g., three different answers from different users 102 that are not the rater) and associate an interaction number of three for that question for the user 102. In other words, the rater (e.g., a user 102) has rated the answers of others and has been associated with an interaction number for the question equal to the number of answers they have rated and the number of times their answer has been rated by others. In some implementations, a required number of interactions may be set because users 102 that have a low number of interactions may have a sum of all their interactions for a question closer to zero or neutral than users 102 with a higher number of interactions. Requiring a predetermined number of interactions may be needed to overcome this bias towards the center. In some implementations, the required number of interactions may be set by a user 102 viewing the results, wherein the minimum value is ‘1’.

In some implementations, the poll engine 106 may be configured to arrange data in order. The data may include respective values associated with users 102 for a particular open-ended question. In some implementations, the data is ordinal. In some implementations, the poll engine 106 is configured to store the data in a database (e.g., database 108) using database storage techniques. Representation of the values in an ordinal fashion may help analysis of the data as answers/opinions represented by data points that are close together or clustered may be assumed to be similar. In some implementations, these values may be displayed on a chart, graph, or using similar data representations to show the relationships between the answers. In some implementations, the poll engine 106 may be configured to include in the results users 102 that do not provide an answer to the question, but rate one or more answers provided by others.

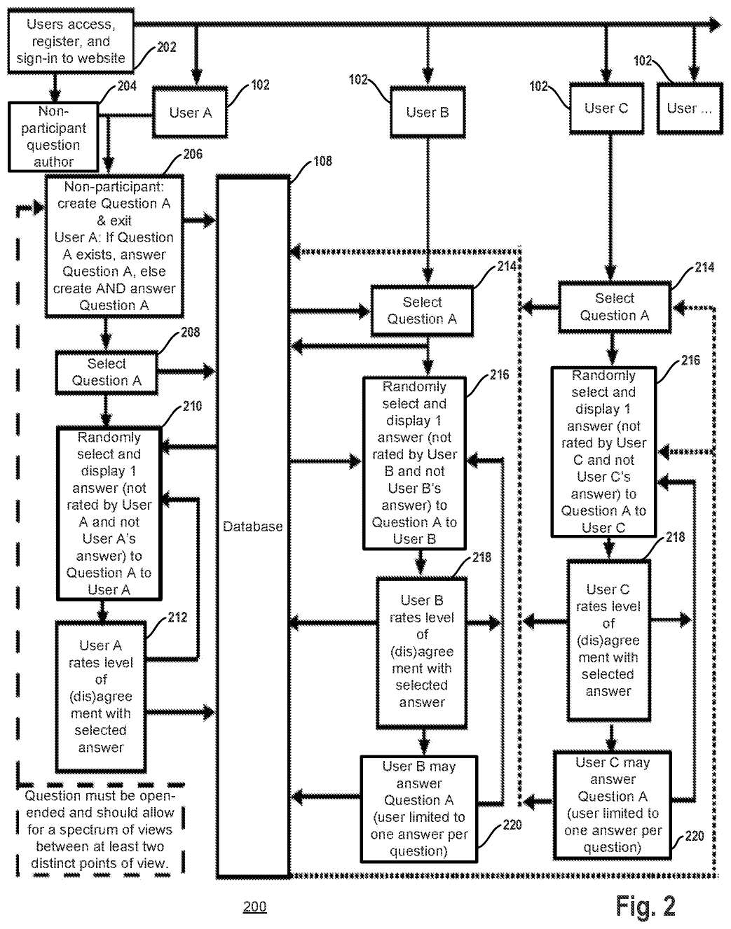

FIG. 2 is an illustration of a block diagram of user interactions 200 added to a database according to an example implementation. In some implementations, steps illustrated in the block diagram of user interactions 200 may be executed using a poll engine 106 using and entering data in a database 108. In some implementations, poll engine 106 executes the steps using a processor 710 (or one or more processors 710) with database 108 implemented in one or more of a storage device 725, a ROM 720, and/or a main memory 715 with users 102 input coming from an input device 730 and output going to a display 735. Users 102 and other components may also be represented by blocks in the block diagram of user interactions 200. For example, users 102 may be represented by blocks such as User A, User B, and so on. Non-participant question authors 204 may also be represented by one or more blocks in the block diagram of user interactions 200. The database 108 is also illustrated with a block and data entry in and out to database 108 is shown.

Regarding step or process 202, users (e.g., users 102) may access, register, and/or sign-in to a website. In some implementations, the website may be users 102 to access and interact with poll interface 104. Registering with the website may allow users 102 to create new questions to create a poll. In some implementations, registration may be required to answer a question or to rate the answers of others to a question. After registration, users 102 may sign into the website to prove their identity. Registration may assign an identifier (e.g., a user ID) to each user 102. In some implementations, a user ID or other numerical identifier may be used to anonymize the entry of questions, answers, rankings, and/or other data entry.

Regarding step or process 206, a question (e.g., question A) is created using the website or other similar user interface. The question may be created by a non-participant question author (e.g., non-participant question author 204). A non-participant question author 204 may create a question for others to answer but does not answer the question or rate the level of agreement/disagreement with the answers of others. The question may be created by a user 102. For example, User A may create a question for others to answer. User A may further provide an answer for their own question. User A may also provide an answer for a question asked by another user 102. In some implementations, User A may answer a question on a topic if the question exists, but otherwise be prompted to provide a question on the topic and provide an answer.

Further regarding step or process 206, in some implementations a question should be written about broad subjects that can be answered with at least two clearly distinct points of view. The question should not be answerable with a “yes” or “no” or other non-substantive answer. In other words, the question should be open-ended and should allow for a spectrum of views between at least two distinct points of view.

Regarding step or process 208, a question (e.g., Question A) is selected. In some implementations, a question may be selected by a relative quantification system 100. In some implementations, a relative quantification system 100 may present two or more questions (e.g., a plurality of questions) for selection by a user (e.g., user 102 or User A).

Regarding step or process 210, an answer to the question in step 208 is selected and displayed to a user (e.g., user 102). The answer may be randomly, pseudo-randomly or systematically selected from two or more possible answers (e.g., a plurality of available answers). In some implementations, the answer presented to User A (e.g., a user 102) may not have been written by User A or previously rated by User A.

Regarding step or process 212, User A (e.g., a user 102) rates the answer presented to them. In some implementations, rating an answer involves selecting a level of agreement or disagreement with the answer. The rating may further use a Likert scale of agreement/disagreement.

Regarding step or process 214, other users 102 (e.g., User B, User C, etc.) may be associated with a question (e.g., question A). In some implementations, a question may be selected by a relative quantification system 100 to be associated with the users 102. In some implementations, a relative quantification system 100 may present two or more questions (e.g., a plurality of questions) for selection by a user 102 (e.g., User B, User C, etc.).

Regarding step or process 216, an answer to the question in step 214 is selected and displayed to other users 102 (e.g., User B, User C, etc.). The answer may be randomly, pseudo-randomly, or systematically selected from two or more possible answers (e.g., a plurality of available answers). In some implementations, the answer presented to users 102 (e.g., User B, User C, etc.) may not have been written or previously rated by the respective user 102.

Regarding step or process 218, users 102 (e.g., User B, User C, etc.) rate the answer presented to them. In some implementations, rating an answer involves selecting a level of agreement or disagreement with the answer. The rating may further use a Likert scale of agreement/disagreement.

Regarding step or process 220, users 102 (e.g., User B, User C, etc.), may answer a question (e.g., Question A). In some implementations, users 102 may be limited to one answer per question.

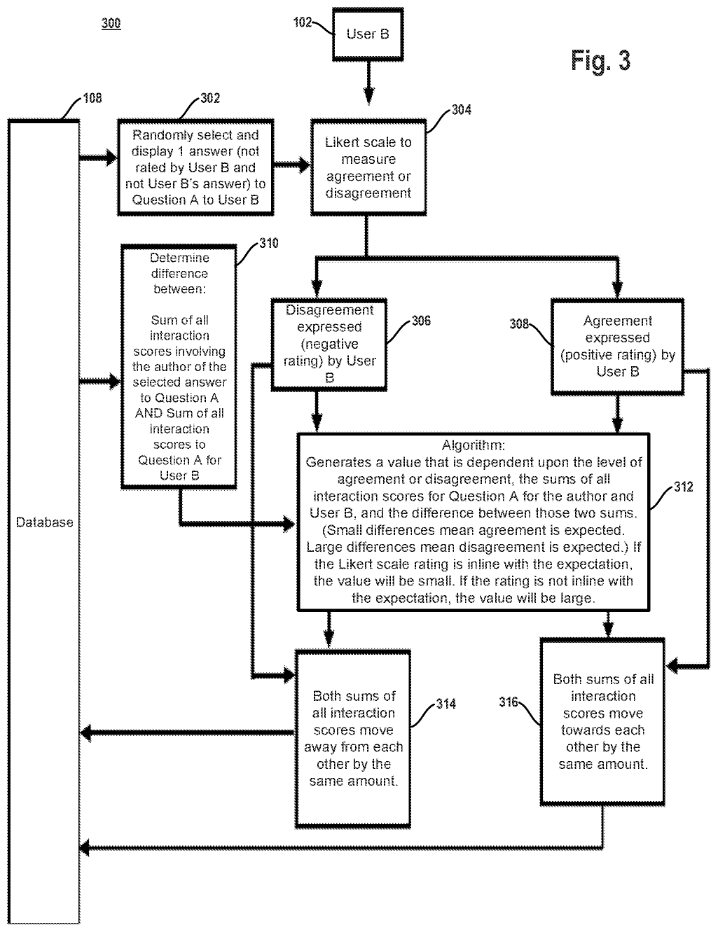

FIG. 3 is an illustration of a block diagram of user interactions 200 added to a database according to an example implementation. FIG. 3 is an illustration of a block diagram of an algorithm to adjust relative interaction scores 300 according to an example implementation. In some implementations, an algorithm to adjust relative interaction scores 300 may be executed using a poll engine 106 using and entering data in a database 108. In some implementations, poll engine 106 executes the steps using a processor 710 (or one or more processors 710) with database 108 implemented in one or more of a storage device 725, a ROM 720, and/or a main memory 715 with users 102 input coming from an input device 730 and output going to a display 735. Users 102 and other components may also be represented by blocks in the block diagram of the algorithm to adjust relative interaction scores 300. For example, users 102 may be represented by blocks such as User B, etc. The database 108 is also illustrated with a block and data entry in and out to database 108 is shown.

Regarding step or process 302, an answer to a question is selected and displayed to a user 102. For example, the block diagram of user interactions 200 shows an example of User B interacting with a relative quantification system 100. In some implementations, an answer to a Question A is randomly, pseudo-randomly, or systematically selected and displayed to User B. The answer may not have been provided by User B or rated by User B. The answer may be randomly, pseudo-randomly, or systematically selected from two or more possible answers (e.g., a plurality of available answers).

Regarding step or process 304, the user 102 (e.g., User B) may input a measure of agreement or disagreement regarding the answer to a question that has been selected and displayed to the user 102. In some implementations, one of the input options may be neither agree nor disagree. In some implementations, one of the input options may be to indicate that the answer is irrelevant and/or not applicable to the question (e.g., Question A). The input of a measure of agreement or disagreement may further use a Likert scale of agreement/disagreement. In step or process 306, the user 102 (e.g., User B) may have expressed disagreement or a negative rating of the answer. In step or process 308, the user 102 (e.g., User B) may have expressed agreement or a positive rating of the answer.

Regarding step or process 310, a difference may be determined between a sum of all interaction scores involving the author of the selected answer to a question (e.g., Question A) and the sum of all interaction scores to the question for a user 102 (e.g., User B). Regarding step or process 312, a value is generated that is dependent upon the level of agreement or disagreement. In some implementations, the value is further based or dependent upon a sum of all interaction scores involving the author of the answer for the question (e.g., Question A). In some implementations, the value is further based or dependent upon a sum of all interaction scores involving User B for the question. In some implementations, the value is further based on the difference between those two sums as may have been calculated in step 310. In some implementations, a calculation of a small difference between two values associated with respective users may indicate that agreement or substantial agreement is expected. In some implementations, a calculation of a large difference between two values associated with respective users may indicate that disagreement or substantial disagreement is expected. In some implementations, if a Likert scale rating is in line with an expectation that there will be agreement or disagreement, the generated value may be expected to be small. In other words, there will not be much change in the relation of interaction scores associated with respective users 102. If the Likert scale rating is not in line with an expectation that there will be agreement or disagreement, the generated value may be larger. In other words, there may be greater change in the relation of interaction scores associated with the respective users 102.

Regarding step or process 314, in some implementations, if there is disagreement between User B and the author of Answer A, then the values associated with the two users 102 move away from each other by the same amount. In other words, a sum of all interaction scores involving the author of the selected answer to Question A and a sum of all interaction scores to Question A involving User B move away from each other by the same amount. Regarding step or process 316, if there is agreement between User B and the author of Answer A, then the values associated with the two users 102 move toward each other by the same amount. In other words, a sum of all interaction scores involving the author of the selected answer to Question A and a sum of all interaction scores to Question A involving User B move toward each other by the same amount.

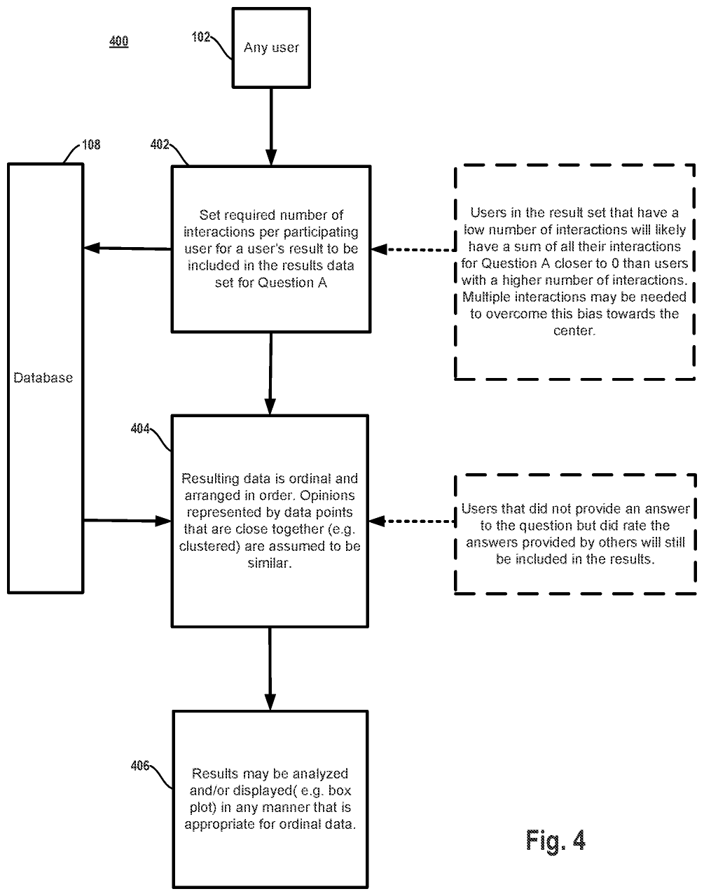

FIG. 4 is an illustration of a block diagram of an algorithm to create results data sets 400 according to an example implementation. In some implementations, an algorithm to create results data sets 400 may be executed using a poll engine 106 using and entering data in a database 108. In some implementations, poll engine 106 executes the steps using a processor 710 (or one or more processors 710) with database 108 implemented in one or more of a storage device 725, a ROM 720, and/or a main memory 715 with users 102 input coming from an input device 730 and output going to a display 735. Users 102 and other components may also be represented by blocks in the block diagram of the algorithm to create results data sets 400. For example, users 102 may be represented by blocks such as Any User, etc. The database 108 is also illustrated with a block and data entry in and out to database 108 is shown.

Regarding step or process 402, a required number of interactions per participating user 102 is set in order for the user's result to be included in the results data set. The results data set may be specific to a particular question. For example, a user 102 may rate three different answers for a given question and be associated with an interaction number of three for that question. In some implementations, a required number of interactions may be set because users 102 that have a low number of interactions may have a sum of all their interactions for question A closer to zero or neutral than users 102 with a higher number of interactions. Requiring a predetermined number of interactions may be needed to overcome this bias towards the center. In some implementations, the predetermined number of interactions may be set by the user. The predetermined number of interactions required may vary when required to allow certain features (e.g., analytical methods, such as correlation or any form of regression, that require a minimum number of values to compare) to function correctly. Should an insufficient number of users for a feature to function meet the predetermined number of interactions, the predetermined number of interactions can be decreased until the required number of users for the feature to function correctly is fulfilled. This effectively establishes a temporary maximum value for the predetermined number of interactions.

Regarding step or process 404, data is arranged in order. The data may include respective values associated with users for a particular open-ended question. In some implementations, the data is ordinal. In some implementations, the data is stored in database 108 using database storage techniques. Representation of the values in an ordinal fashion may help analysis of the data as answers/opinions represented by data points that are close together or clustered may be assumed to be similar. In some implementations, these values may be displayed on a chart, graph, or using similar data representations to show the relationships between the answers/opinions as in step or process 406. In some implementations, users 102 that do not provide an answer to the question, but rate one or more answers provided by others, may still be included in the results.

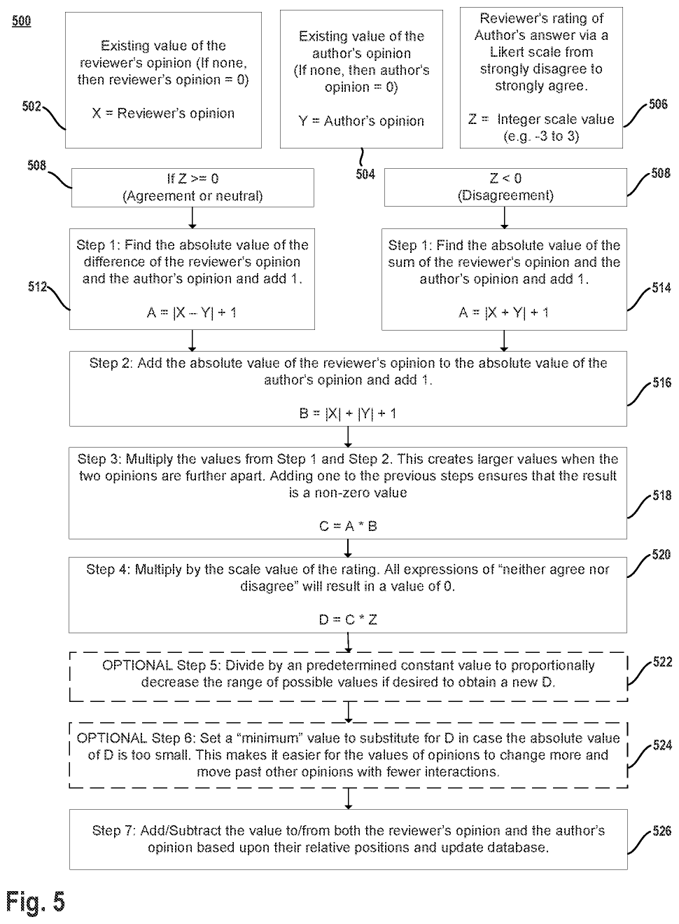

FIG. 5 is an illustration of a block diagram of a detailed algorithm to adjust relative interaction scores 500 according to an example implementation. In some implementations, a detailed algorithm to adjust relative interaction scores 500 may be executed using a poll engine 106 using and entering data in a database 108. In some implementations, poll engine 106 executes the steps using a processor 710 (or one or more processors 710) with database 108 implemented in one or more of a storage device 725, a ROM 720, and/or a main memory 715 with users 102 input coming from an input device 730 and output going to a display 735. Blocks may also represent existing data such as the existing value of a reviewer's opinion 502, where the existing value of the reviewer's opinion 502 is representative of a reviewer's ratings of one or more other answers associated with a relevant question. In some implementations, the existing value of the reviewer's opinion 502 may be represented by ‘X’. In some implementations, X may be equal to zero if there is no existing value of the reviewer's opinion 502. Blocks may also represent existing data such as the existing value of the author's opinion 504 (the author of the relevant question), where the existing value of the author's opinion 504 is representative of the author's ratings of one or more answers that have not been provided by the author associated with the relevant question. In some implementations, the existing value of the author's opinion 504 may be represented by ‘Y’. In some implementations, Y may be equal to zero if there is no existing value of the author's opinion 504. Blocks may also represent newly received data such as a value of rating of an answer (e.g., the author's answer) where the received value of rating is representative of a rating via a Likert scale from strongly disagree to strongly agree. In some implementations, the received value of the rating may be represented by ‘Z’. In some implementations, Z may have a numeric value on an integer scale (e.g., the Likert scale is an integer scale value from −3 to 3).

Regarding decision 508, if Z>=0, then the method may move on to step or process 512. In other words, if the reviewer's rating is neutral or in agreement with the author's answer, then the method may move on to step or process 512. If Z<0, then the method may move on to step or process 514. In other words, if the reviewer's rating is in disagreement with the author's answer, then the method may move on to step or process 514.

Regarding step or process 512, the absolute value of the difference of the reviewer's opinion and the author's opinion is calculated. In some implementations, one may be added to the difference of the reviewer's opinion and the author's opinion. One may be added to ensure that the result is a non-zero value.

Regarding step or process 514, the absolute value of the sum of the reviewer's opinion and the author's opinion is calculated. In some implementations, one may be added to the sum of the reviewer's opinion and the author's opinion. One may be added to ensure that the result is a non-zero value.

Regarding step or process 516, the absolute value of the reviewer's opinion added to the absolute value of the author's opinion is calculated. In some implementations, one may be added to the calculated value. One may be added to ensure that the result is a non-zero value.

Regarding step or process 518, a calculation may be performed to multiply the value obtained from step or process 516 and either step or process 512 or step or process 514. For example, a calculation may be to find a first value that is the absolute value of the difference of the reviewer's opinion and the author's opinion and adding one, find a second value that is the sum of the absolute value of the reviewer's opinion to the absolute value of the author's opinion, and multiply the first value and the second value together. In another example, a calculation may be to find a first value that is the absolute value of the sum of the reviewer's opinion and the author's opinion and adding one, find a second value that is the sum of the absolute value of the reviewer's opinion to the absolute value of the author's opinion, and multiply the first value and the second value together. In some implementations, multiplying the values may create larger values when the two opinions are further apart.

Regarding step or process 520, the result from step or process 518 may be multiplied by the scale value determined from step or process 506. In some implementations, where the scale value may be set to zero, this may result in a calculation of zero. For example, a Likert scale is used in step or process 506 where zero is set to mean “neither agree nor disagree,” the scale value determined in step or process 506 is zero, the value determined in step or process 518 is multiplied by zero, and the resultant value is zero.

Regarding step or process 522, the value determined in step or process 520 is divided by a predetermined constant value. In some implementations, this may be done to proportionally decrease the range of possible values. In some implementations, step or process 522 is an optional step or process.

Regarding step or process 524, the value determined in step or process 520 or in step or process 522 may be substituted with a minimum value if the absolute value of “D” determined in step or process 520 or in step or process 522 is determined to be below a predetermined threshold value. For example, the absolute value of “D” is determined to be too small and is substituted with a minimum value. In some implementations, this may make it easier for the values of opinions to change more and move past other opinions with fewer interactions. In some implementations, step or process 524 is an optional step or process.

Regarding step or process 526, the value determined in step or process 520 is added or subtracted to/from both the reviewer's opinion and the author's opinion. In some implementations, this results in values associated with the reviewer and the author to move closer to each other when there is agreement and further away from each other when there is disagreement.

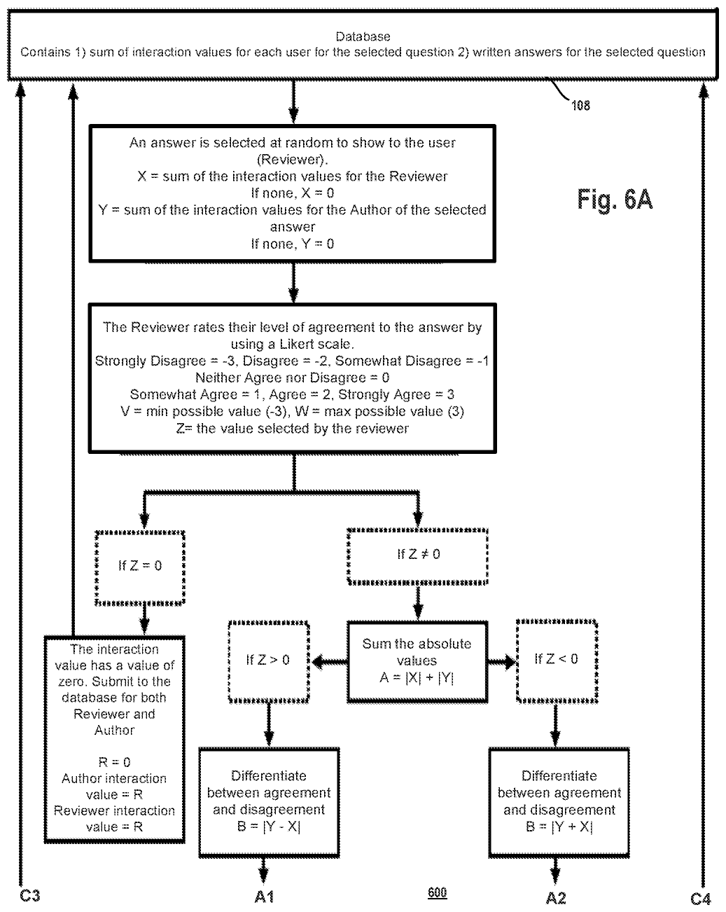

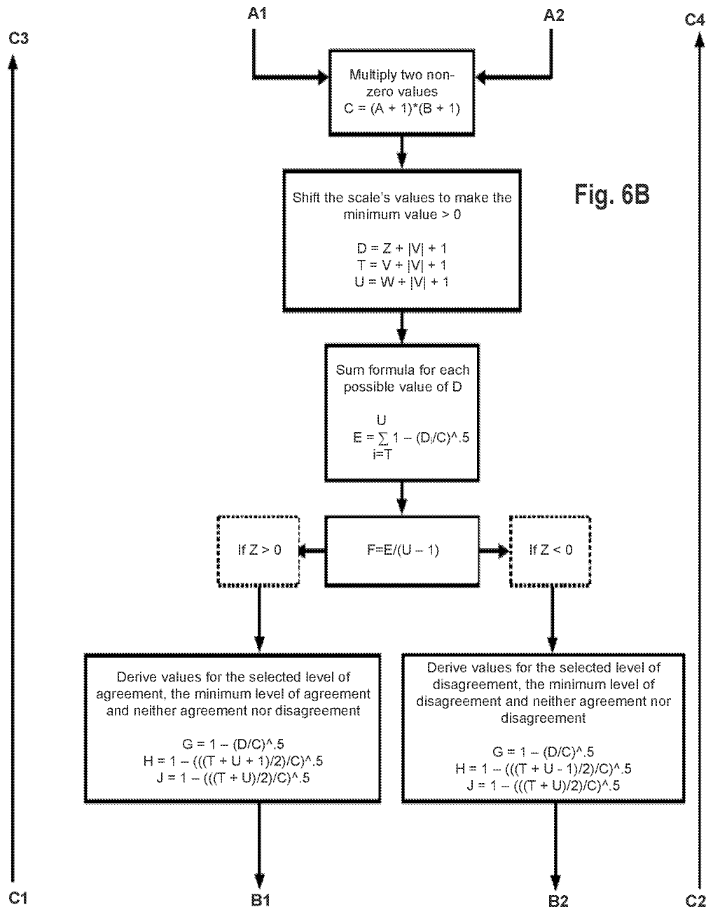

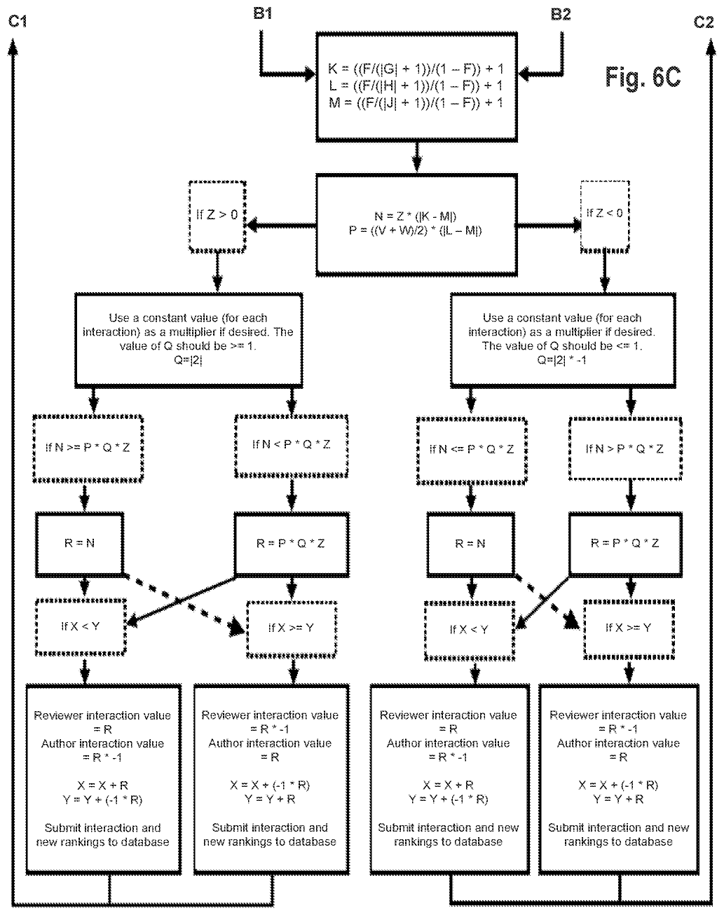

FIGS. 6a-6c are an illustration of a detailed algorithm related to the steps or processes of FIG. 5 and is an example implementation of a detailed algorithm 600 to adjust relative interaction scores. In some implementations, a detailed algorithm to adjust relative interaction scores 600 may be executed using a poll engine 106 using and entering data in a database 108. In some implementations, poll engine 106 executes the steps using a processor 710 (or one or more processors 710) with database 108 implemented in one or more of a storage device 725, a ROM 720, and/or a main memory 715 with users 102 input coming from an input device 730 and output going to a display 735.

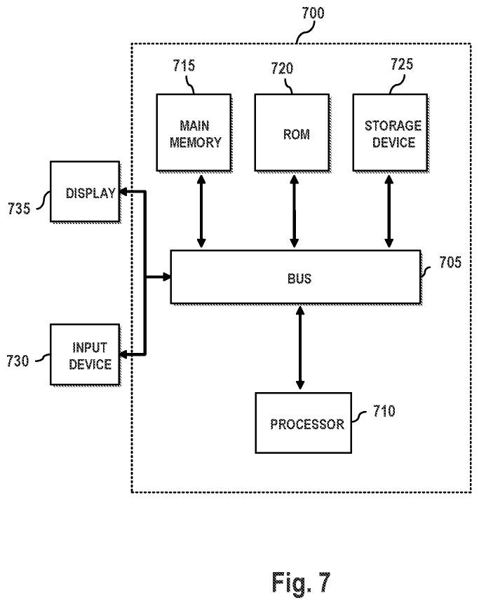

FIG. 7 is a block diagram of a computer system in accordance with an illustrative implementation. The computer system or computing device 700 or individual components therein may be used to implement the user(s) 102, the poll interface 104, the poll engine 106, database 108 etc. The computing system 700 includes a bus 705 or other communication component for communicating information and a processor 710 or processing circuit coupled to the bus 705 for processing information. The computing system 700 can also include one or more processors 710 or processing circuits coupled to the bus for processing information. The computing system 700 also includes main memory 715, such as a random access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 710 or other static storage device coupled to the bus 705 for storing static information and instructions for the processor 710. A storage device 725, such as a solid state device, magnetic disk or optical disk, is coupled to the bus 705 for persistently storing information and instructions.

The computing system 700 may be coupled via the bus 705 to a display 735, such as a liquid crystal display or active matrix display, for displaying information to a user. An input device 730, such as a keyboard including alphanumeric and other keys, may be coupled to the bus 705 for communicating information and command selections to the processor 710. In another implementation, the input device 730 has a touch screen display 735. The input device 730 can include a cursor control, such as a mouse, a trackball, or cursor direction keys, for communicating direction information and command selections to the processor 710 and for controlling cursor movement on the display 735.

According to various implementations, the processes described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to effect illustrative implementations. Thus, implementations are not limited to any specific combination of hardware circuitry and software.

Although an example computing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments and/or implementations, are intended to indicate that such embodiments are possible examples, representations, or illustrations of possible embodiments and implementations (and such terms are not intended to connote that such embodiments and/or implementations are necessarily extraordinary or superlative examples).

The term “affixed” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems and methods shown in the various exemplary embodiments or implementations are illustrative only. Additionally, any element disclosed in one embodiment or implementation may be incorporated or utilized with any other embodiment or implementation disclosed herein.

What is claimed is:

1. An ordinal data quantifying system comprising:
a poll interface;
a poll engine; and
a database,
wherein (a) the poll engine is configured to
(i) receive an open-ended question,
(ii) receive a first answer to the open-ended question from a first user using the poll interface,
(iii) generate, using the database, a first user opinion value comprising a first sum comprising all interaction values associated with the first user rating respective answers to the open-ended question, the answers not including the first answer when the first user wrote the open-ended question,
(iv) receive a rating of the first answer from a second user using the poll interface,
(v) generate, using the database, a second user opinion value comprising a second sum comprising all interaction values associated with the second user rating respective answers to the open-ended question including the first answer from the second user,
(vi) generate a new interaction value based on the first sum comprising all interaction values, the second sum comprising all interaction values, and the rating of the first answer from the second user, and
(vii) adjust a position of the first user and a position of the second user in an ordinal data set based on the new interaction value,
(b) the interaction values are based on evaluations of ratings based on a scale measuring agreement or disagreement, and
(c) the first user opinion value and the second user opinion value numerically represent the respective user's opinion.

2. The system of claim 1, wherein the poll system is further configured to:
randomly, pseudo-randomly, or systematically select the first answer from a plurality of answers to the open-ended question, and
send the first answer to the second user using the poll interface.

3. The system of claim 1, wherein the scale measuring agreement or disagreement is a Likert scale.

4. The system of claim 1, wherein the poll system is further configured to:
compare the position of the first user and the position of the second user,
determine the first user and the second user are closer in the ordinal data set than a predetermined threshold amount, and
predict an answer to a second open-ended question by the second user based on an answer to the second open-ended question by the first user.

5. The system of claim 4, wherein the second open-ended question is related to the open-ended question.

6. The system of claim 5, wherein the poll system is further configured to present the predicted answer to the second open-ended question to the second user as a possible answer using the poll interface.

7. The system of claim 1, wherein the poll system is further configured to:
compare the position of the first user and the position of the second user,
generate a compromise answer in between an answer associated with the first user and an answer associated with the second user based on the comparison, and
present the compromise answer to at least one of the first user or the second user using the poll interface.

8. The system of claim 7, wherein generating the compromise answer comprises determining an answer associated with a user with a position between the position of the first user and the position of the second user in the ordinal data set.

9. The system of claim 1, wherein the poll system is further configured to: generate a graphic of all ordinal data in the ordinal data set including the position of the first user and the position of the second user, wherein the positions are expressed and presented in order from negative to positive.

10. The system of claim 9, wherein a user viewing the graphic can interact with a graphic representing each respective user to view an answer associated with the respective user using the poll interface.

11. The system of claim 1, wherein the poll system is further configured to: generate a graphic of all answers placed in positions associated respective users using the ordinal data set including the position of the first user and the position of the second user.

12. The system of claim 11, wherein a user viewing the graphic can interact with a graphic representing each respective answer to view information about a user associated with the respective answer using the poll interface.

13. A method of quantifying users into ordinal data, executing on a computing system, the method comprising:
receiving an open-ended question;
receiving a first answer to the open-ended question from a first user;
generating a first user opinion value comprising a first sum comprising all interaction values associated with the first user rating respective answers to the open-ended question, the answers not including the first answer when the first user wrote the open-ended question;
receiving a rating of the first answer from a second user;
generating a second user opinion value comprising a second sum comprising all interaction values associated with the second user rating respective answers to the open-ended question including the first answer from the second user, wherein (i) the interaction values are based on evaluations of ratings based on a scale measuring agreement or disagreement and (ii) the first user opinion value and the second user opinion value numerically represents the respective user's opinion;
generating a new interaction value based on the first sum comprising all interaction values, the second sum comprising all interaction values, and the rating of the first answer from the second user; and
adjusting a position of the first user and a position of the second user in an ordinal data set based on the new interaction value.

14. The method of claim 13, further comprising:
randomly, pseudo-randomly, or systematically selecting the first answer from a plurality of answers to the open-ended question; and
sending the first answer to the second user.

15. The method of claim 13, wherein the scale measuring agreement or disagreement is a Likert scale.

16. The method of claim 13, further comprising:
comparing the position of the first user and the position of the second user;
determining the first user and the second user are closer in the ordinal data set than a predetermined threshold amount; and
predicting an answer to a second open-ended question by the second user based on an answer to the second open-ended question by the first user.

17. The method of claim 16, wherein the second open-ended question is related to the open-ended question.

18. The method of claim 17, further comprising, presenting the predicted answer to the second open-ended question to the second user as a possible answer.

19. The method of claim 13, further comprising:
comparing the position of the first user and the position of the second user;
generating a compromise answer in between an answer associated with the first user and an answer associated with the second user based on the comparison; and
presenting the compromise answer to at least one of the first user or the second user.

20. The method of claim 7, wherein generating the compromise answer comprises determining an answer associated with a user with a position between the position of the first user and the position of the second user in the ordinal data set.
